(19) United States
(12) Patent Application Publication
(10) Pub. No.: US 2007/0111079 A1
(43) Pub. Date: May 17, 2007

(54) SEPARATOR FOR FUEL CELL

(75) Inventors: Satoru Terada, Saitama (JP); Daisuke Okonogi, Saitama (JP)

Correspondence Address: ARENT FOX PLLC, 1050 CONNECTICUT AVENUE, N.W., SUITE 400, WASHINGTON, DC, 20036, US

(73) Assignee: HONDA MOTOR CO., LTD., Tokyo (JP)

(21) Appl. No.: 11/558,105

(22) Filed: Nov. 9, 2006

(30) Foreign Application Priority Data
Nov. 11, 2005 (JP) 2005-327096

(51) Int. Cl. H01M 8/02

(52) U.S. Cl. 429/34; 429/38

(57) ABSTRACT

In an insulating coating formed at a portion that contacts a coolant of a separator for a fuel cell, blisters (water-filled bulges) are prevented from forming. In a structure in which a primer layer is formed on the surface of an anode side metal separator facing a gap for flowing coolant and an insulating coating is formed on the primer layer, the value of (measured resistance value/calculated theoretical resistance value) of the primer layer is set to 95% or more. By satisfying this condition, the primer layer, having few fine voids, in which it is difficult for vapor components of the coolant to penetrate, can be formed, and blisters due to condensation of the vapor component of the coolant can be prevented from forming.

### BACKGROUND OF THE INVENTION

1. Field of the Invention

The present invention relates to techniques for preventing a phenomenon in which an insulating coating formed on a surface of a separator of a fuel cell swells due to water penetrating inside, and in particular, relates to a technique for improving the physical properties of a primer layer under the insulating coating.

2. Background Art

As a separator in a solid polymer electrolyte fuel cell, a sealed and integrated metal separator which unites a seal member is known (Japanese Unexamined Patent Application No. 2004-207071). In addition, a technology for forming an insulating coating in the vicinity of a continuous hole for discharging coolant of a metal separator is known, in order to prevent the corrosion of a metal separator due to leakage current which flows through the coolant (Japanese Unexamined Patent Application No. 2005-222764). This structure, in which an insulating coating is formed, has a structure in which a primer layer as a base layer is formed on the surface of a metal separator and an insulating coating made of a rubber material is formed thereon.

The solid polymer electrolyte fuel cell has a desired voltage by stacking a large number (dozens or more) of unit power generating cells. The solid polymer electrolyte fuel cell is being developed as a power source for electric automobiles; however, further miniaturization and weight reduction are required in order to mount it in such automobiles. Therefore, it is also required that the above insulating coating in the metal separator be formed as thin as possible.

However, in the case in which the insulating coating is made thinner, a phenomenon occurs in which the cooling effect by the coolant is deteriorated over long-term operation and generating capacity is decreased. This occurs due to the development of blisters (water-filled bulges) in the insulating coating which is in contact with the coolant, by the blisters blocking a path for flowing the coolant between the separators, which is set to be narrow, and by preventing the coolant from flowing to the surface of the separator.

In the following, this problem will be explained. FIG. 4 is a sectional view showing a part of a cross section structure of the solid polymer electrolyte fuel cell using the sealed and integrated metal separator. In FIG. 4, a structure in which are stacked a unit power generating cell 600a and a unit power generating cell 600b is shown. The unit power generating cell 600a has a basic structure which sandwiches an MEA (Membrane Electrode Assembly) 603 between an anode side metal separator 601 and a cathode side metal separator 602. On an MEA 603 side of the anode side metal separator 601, an oxidizer gas supplying groove 604 for supplying oxidizer gas (for example, air) to the MEA 603 is formed. In addition, on a cathode side metal separator 602, a fuel gas supplying groove 605 for supplying fuel gas (for example, hydrogen gas) in the MEA 603 is formed. The unit power generating cell 600b also has a structure that is similar to that of the unit power generating cell 600a, although the structure is not shown.

A gap for flowing coolant 606, through which flows a coolant (for example, pure water), is provided between the adjoining unit power generating cells 600a and 600b. In this embodiment, the coolant flowing from the gap 606 is discharged to a continuous hole 610 which passes through each unit power generating cell, and it is discharged through the hole to the fuel cell outside.

Near an edge of the gap for flowing coolant 606 which is connected to the continuous hole for discharging coolant 610, an insulating coating 608 for preventing leakage current from being generated through coolant between the adjoining unit power generating cells 600a and 600b is formed. The insulating coating 608 is made of a rubber material, and it also functions as a sealing member between the adjoining separators in other parts. Then, between the insulating coating 608 and material which constitutes the separator (for example, a stainless steel alloy), a primer layer 607 for improving adhesion therebetween is formed.

In the case in which a power generating operation is carried out in this structure, the coolant remains at an interface between the primer layer 607 and the material which constitutes the separator, and blisters (water-filled bulges) 609 are formed. Since the space of the gap for flowing coolant 606 is also narrow in the solid polymer electrolyte fuel cell which is desired to be reduced in size, a problem occurs in that the gap 606 for flowing coolant is easily blocked by the blister 609, as shown by the figure, and the coolant is easily prevented from flowing. In the case in which flow is prevented, cooling efficiency by the coolant is decreased, and therefore, the generating capacity is deteriorated.

The present inventors have discovered the following as a result of analyzing this mechanism of the blister development. First, in the operation of the fuel cell, the temperature of the metal separator is increased to 80 to 90° C. by the action of generating power. At this time, since the temperature of the coolant is also increased, the vapor pressure thereof is increased, and the coolant is easily vaporized, and the coolant vapor (vapor) penetrates into the insulating coating 608. The evaporated coolant penetrating into this insulating coating 608 also penetrates into the fine voids (fine defects produced in the forming thereof) of the primer layer 607. In an in-vehicle type fuel cell, it is necessary to control output depending on running conditions, and for example, when stopping the car, an operation control in which the power output is decreased from a fixed value to zero is carried out. In such an operation, the temperature of a metal portion under the insulating coating 608 is often lower than that of the coolant that is in contact with the insulating coating 608 near the periphery of the separator. That is, the coolant is heated by transferring heat from the separator, whereas in contrast, the separator itself is cooled by natural cooling (for example, cooling by conducting heat to adjoining members) after stopping the power generation, and consequently, the temperature of the coolant and the temperature of the separator are often reversed. In particular, this phenomenon easily occurs since the temperature of the coolant is high near the exit of the gap for flowing coolant 606 shown in FIG. 4.

In the case in which the temperature of the coolant and the temperature of the separator are reversed, the coolant vapor which penetrated into the insulating coating 608 and into the fine voids of the primer layer 607 is easily condensed. Since it is difficult for the condensed coolant to penetrate into the primer layer 607 and the insulating coating 608, the primer layer 607 and the insulating coating 608 are bulged and the condensed coolant remains in liquid form between the primer layer 607 and the surface of the separators 602. In particular, near the interface between the primer layer 607 and the surface of the separators 602, the coolant vapor is directly in contact with the separator 602 which decreases the temperature thereof, and as a result, the vapor component of the coolant is preferentially condensed and the coolant tends to remain as a liquid. Therefore, according to such a mechanism, the blister (water-filled bulges) 609 is generated.

### SUMMARY OF THE INVENTION

An object of the present invention is to provide a separator for fuel cells in which formation of the blister as described above can be prevented.

The present invention provides a separator for a fuel cell which will be in contact with a coolant, the separator including an electroconductive plate member, a primer layer formed on the surface of the plate member which contacts the coolant, and an insulation coating formed on the primer layer, in which a value (measured resistance value/calculated theoretical resistance value) of the primer layer is 95% or more. According to the present invention, the vapor component of the coolant that reaches the interface between the electroconductive plate member and the primer layer which constitute the separator, can be decreased, since a fine structure, in which it is difficult for the coolant vapor to penetrate, as a primer layer can be realized. Therefore, the formation of blisters in the primer layer can be prevented, even if there is a reduced temperature at a substrate part of the separator when power output of the fuel cell is greatly decreased. In short, the vaporized component of the coolant is prevented from penetrating by making the primer layer finer, and thereby the formation of the blisters due to condensation can be prevented, even if the environment is at a temperature in which the vapor component condenses. In addition, density of a core which is necessary for condensing the vapor component of the coolant can be decreased by making the primer layer finer and by decreasing the density of the fine voids. This is also effective in the prevention of the condensation of the vapor component of the coolant in the interface between the primer layer and the plate member, thereby preventing the formation of blisters. In the case in which it is microscopically observed, the fine voids part is a non-adhered part in which the material which constitutes the primer layer is not adhered, and the fine voids can be also considered to be small voids which are sources for the formation of the blisters. According to the present invention, the non-adhered part in the above microscopic observation is decreased and the primer layer having a certainly and uniformly adhered structure can be produced. This is also effective in decreasing the sources of formation of the blisters and in the prevention of formation of the blisters thereby.

The primer layer is a ground layer for improving adhesion of the insulating coating to the electroconductive plate member which constitutes the separator. As a primer layer, for example, a silane coupling agent can be employed. As an insulating coating, a rubber material such as EPDM, silicone rubber, fluoro rubber, fluoro silicone rubber, perfluoro rubber, blended rubber thereof, etc., can be used. As a coolant, pure water and pure water to which an antifreeze solution such as ethylene glycol has been added can be employed, and in particular, the contained components are not limited, so long as the state thereof is liquid. The present invention is more effective in the case in which the plate member is made of a metal such as a stainless steel alloy (in the case in which it is a metal separator). However, a plate member made of carbon material or resin material can also be employed.

The measured resistance value is an electric resistance value in a thickness direction of the primer layer in which the electrolyte penetrates. The calculated theoretical value is a theoretical resistance value in a thickness direction of the primer layer calculated from a specific resistance value of the material which constitutes the primer layer and the thickness of the primer layer.

In the present invention, the closer to 100% the value of the measured resistance value/the calculated theoretical resistance value is, the less the density of the fine voids in the primer layer. In contrast, as the value of the measured resistance value/the calculated theoretical resistance value decreases from 100%, the greater the density of the fine voids in the primer layer. That is, the density of the fine voids included in the primer layer can be evaluated by the value of the measured resistance value/the calculated theoretical resistance value of the primer layer.

The fine voids existing in the primer layer have a great effect on penetration conditions of the coolant vapor, as described above. That is, in the case in which the density of the fine voids that exist in the primer layer is high, penetration of the coolant vapor is greater and the formation of the blisters is also more prominent. By experiment, it has been demonstrated that the formation rate of the blisters can be 1% or less if the value of the measured resistance value/the calculated theoretical resistance value in the primer layer is 95% or more. The formation rate of the blisters is calculated from the value (area of the generated blister/area of test surface).

In order to satisfy the conditions in which the value of the measured resistance value/the calculated theoretical resistance value in the primer layer is 95% or more, use of a method which repeats coating for forming the primer layer a number of times (so-called “recoating”), is effective. The number of coating which is necessary can be experimentally determined by the value of the measured resistance value/the calculated theoretical resistance value. In addition, a method in which the dilution rate is increased when the material which constitutes the primer layer is coated, and simultaneously, the number of times of coating is increased, is also effective. It is believed that the recoating is effective since an effect for repairing defective portions formed in the last coating is repeated by the recoating and number of the defective portions is decreased thereby. In addition, it is believed that the recoating of diluted coating material is effective, since the viscosity of the coating material is reduced by dilution in addition to the above effect of recoating, and the coating material is easily disposed into the defective portions. As another method for adjusting the value of the measured resistance value/the calculated theoretical resistance value, a method for controlling a temperature condition or a humidity condition in the coating process and a method using ultrasonic vibrations, can be employed.

The measured resistance value in the present invention is measured as a resistance value in a thickness direction of the primer layer in a condition in which the electrolyte penetrates. In the case in which the density of the fine voids in the primer layer is high, since substantial amounts of the electrolyte penetrated, the path of electrical conduction through the electrolyte is increased and the electrical resistance is reduced. As a result, the value of the measured resistance value/the calculated theoretical resistance value is decreased. Therefore, in the case in which the value of the measured resistance value/the calculated theoretical resistance value is low, vapor easily penetrates into the voids and the blisters are easily formed. This is clear from the data shown in the graph of FIG. 2. Thus, by the evaluation of the value of the measured resistance value/the calculated theoretical resistance value as an index, the density of the fine voids in the primer layer can be quantitatively measured, and it can be useful to prevent the formation of the blisters. Here, the electrolyte is not limited, so long as it is a neutral electrolyte such as a NaCl solution, etc.

The present invention is suitable for application to a part in which the temperature of a plate member which constitutes the separator may be lower than the temperature of coolant which contacts an insulating coating of the part. That is, in the case in which the fixed portion of the separator is put in such a thermal environment, the vapor component of the coolant penetrating the insulating coating is easily condensed by transferring the heat of the portion to the plate member which constitutes the separator. By applying the present invention to the primer layer on such a portion, the primer layer on such a portion is made finer and the coolant vapor component can be prevented from penetrating into the primer layer on the portion. Then, components that occur due to condensation can be prevented from existing in the primer layer and the blisters can be prevented from forming, even if the thermal environment is at temperatures in which the coolant vapor component is condensed.

According to the present invention, the fineness of the primer layer is ensured by setting the value of the measured resistance value/the calculated theoretical resistance value in the primer layer to be 95% or more, and thereby the vapor component of the coolant which causes the blisters to form can be prevented from penetrating into the primer layer. Consequently, the blisters can be prevented from forming and the generating capacity can be prevented from being reduced due to the formation of the blisters.

Additionally, in the present invention, it is preferable that the insulation coating be formed on a peripheral region of a continuous hole which passes through each unit power generating cell and supplies or discharges coolant. According to this aspect, the insulation coating is not formed on a power generating surface of the separator, and therefore, a cooling effect by the coolant is superior and in addition, adjoining cells are preferably electrically connected. Furthermore, in the present invention, it is preferable that the insulation coating be also formed near an edge of a gap for distributing the coolant. According to this aspect, the insulation coating is limitedly formed on a portion which tends to form the blister.

### BRIEF DESCRIPTION OF THE DRAWINGS

FIG. 1 is a sectional view showing a fuel cell using a separator according to the present invention.

FIG. 2 is a graph showing the relationship between (measured resistance value/calculated theoretical resistance value) of a primer layer and formation rate of blisters.

FIG. 3 is a schematic drawing showing a method for measuring the measured resistance value of the primer layer.

FIG. 4 is a sectional view showing a formation state of the blisters in the conventional art.

### BEST MODE FOR CARRYING OUT THE INVENTION

### 1. FIRST EMBODIMENT

(1) Composition

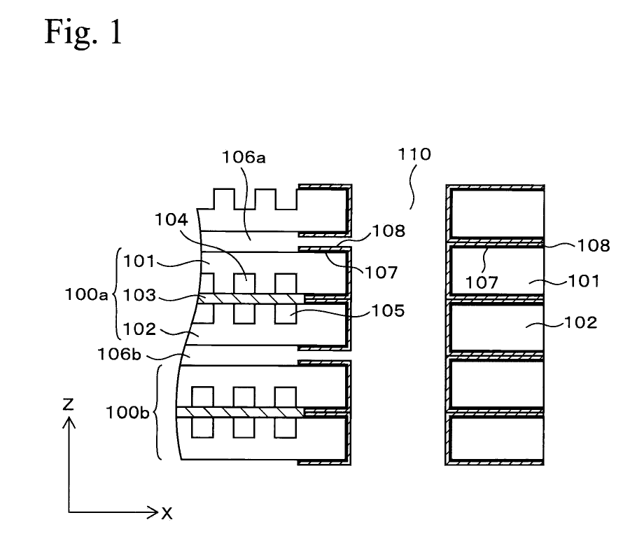

FIG. 1 is a sectional view showing a solid polymer electrolyte fuel cell using a sealed integrated metal separator according to the present invention. In FIG. 1, a structure is shown in which unit power generating cells, represented by numerous references 100a and 100b, are stacked. FIG. 1 shows only a basic stacked structure; however, in an actual fuel cell, the stacked structure in which a large number of the illustrated basic structures are repeated is employed.

The unit generating cell 100a has a basic structure which sandwiches an MEA (Membrane Electrode Assembly) 103 between an anode side metal separator 101 and a cathode side metal separator 102. The MEA is an electrolyte membrane complex, and it is a member containing a catalyst in which reaction for carrying out power generation is generated. On an MEA 103 side of the anode side metal separator 101, an oxidizer gas supplying groove 104 which supplies oxidizer gas (for example, air) to the MEA 103 is formed, and on the cathode side metal separator 102, a fuel gas supplying groove 105 which supplies fuel gas (for example, hydrogen gas) to the MEA 103 is formed. The unit power generating cell 100b also has a structure which is similar to that of the unit power generating cell 100a, although it is not illustrated.

The reference numerals 106a indicate gaps for distributing coolant, which is a coolant supplying path. In the present embodiment, pure water to which antifreeze (ethylene glycol) has been added is supplied as coolant to the gap for distributing coolant 106a. The anode side metal separator 101 of the unit power generating cell 100a which faces to the gap for distributing coolant 106a and the cathode side metal separator of the unit power generating cell which is upward are cooled by the coolant. A gap for distributing coolant 106b having a structure similar to that of the gap for distributing coolant 106a is formed between the unit power generating cell 100a and the unit power generating cell 100b. The gaps for distributing coolant 106a and 106b are set to flow the coolant from the gaps 106a and 106b to a continuous hole for discharging coolant 110 which passes through each unit power generating cell.

On the anode side metal separator 101 near an edge of the gap for distributing coolant 106a that connects to the continuous hole for discharging coolant 110, a primer layer 107 is formed and an insulating coating 108 is formed on the primer layer 107. The primer layer 107 is a layer for improving adhesion of the insulating coating 108 to the anode side metal separator 101, and it is formed by coating a silane coupling agent thereon. The insulating coating 108 is formed of a silicone rubber, and it has an elasticity which is necessary for sealing, in addition to electrical insulation. A path of leakage current (length in which a potential difference occurs) using the coolant between the adjoining unit power generating cells is extended by forming the insulating coating 108 near the edge of the gap for distributing coolant 106a, so as to prevent the occurrence of current leakage. In addition, the insulating coating 108 has characteristics which ensure sealing and insulation between the adjoining separators, and which ensure sealing and insulation between the anode side metal separator 101 and the cathode side metal separator 102. A similar structure to that of the insulating coating is formed in other separators.

(2) Production Method

Here, a method for producing the above anode side metal separator 101 is explained. First, a stainless steel alloy which has been cut in a desired shape is press-molded, and the anode side metal separator 101 is formed. Next, the primer layer 107 is formed by coating a silane coupling agent diluted using a solvent. A pretest of the coating condition in this coating step is previously carried out, and diluting concentration and the number of times coating is to be conducted are decided. Here, the diluting concentration and the number of times coating is to be conducted are decided, so that the (measured resistance value/calculated theoretical resistance value) of the formed primer layer 107 is 95% or more, and the primer layer 107 is formed on the basis of the conditions. In this way, the anode side metal separator 101 shown in FIG. 1 is produced.

(3) Operation

First in a structure of the fuel cell shown in FIG. 1, when air is run through the oxidizer gas supplying groove 104 and hydrogen gas is run through the fuel gas supplying groove 105, hydrogen contacted with the MEA (Membrane Electrode Assembly) 103 is converted to hydrogen ions (H⁺ ions) by a catalytic reaction. The hydrogen ions penetrate in the MEA 103 and combine with oxygen in air at the anode side, and water is formed at the anode side of the MEA 103. In this case, the potential of the anode side metal separator 101 is higher than that of the cathode side metal separator 102, since electrons lost from hydrogen by the ionization go to the cathode side metal separator 102. Since this action occurs in each unit power generating cell which is stacked, current flows and power generation is carried out, and a load is applied between the anode side metal separator of the unit power generating cell which is at one side of the stacked structure connected in series and the cathode side metal separator of the unit power generating cell which is at the other side.

(4) Improving Effect of Primer Layer

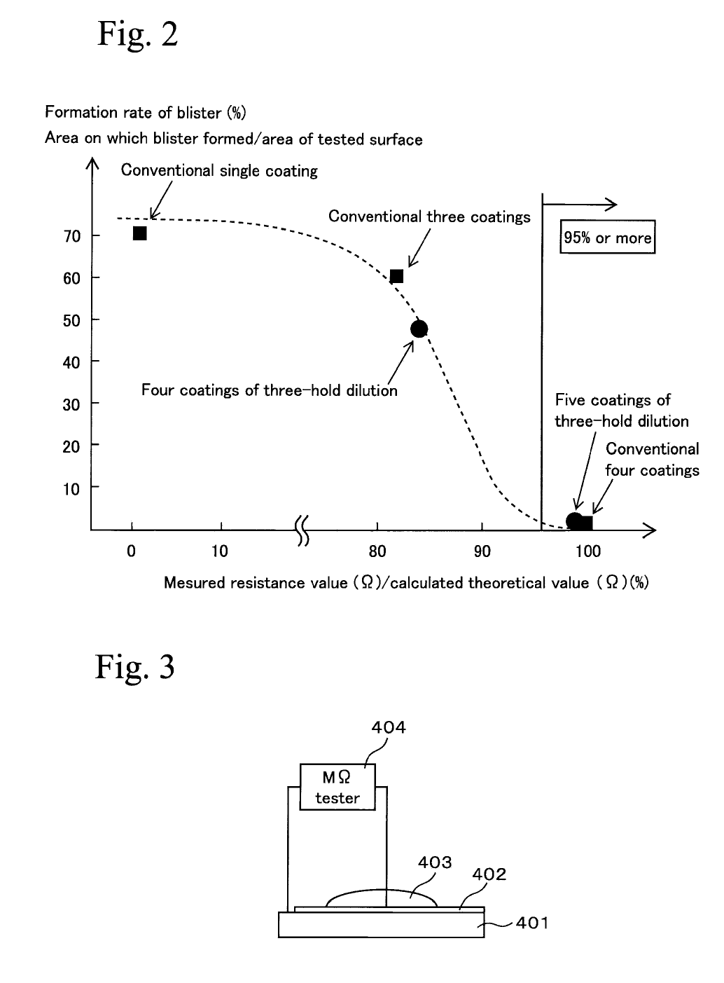

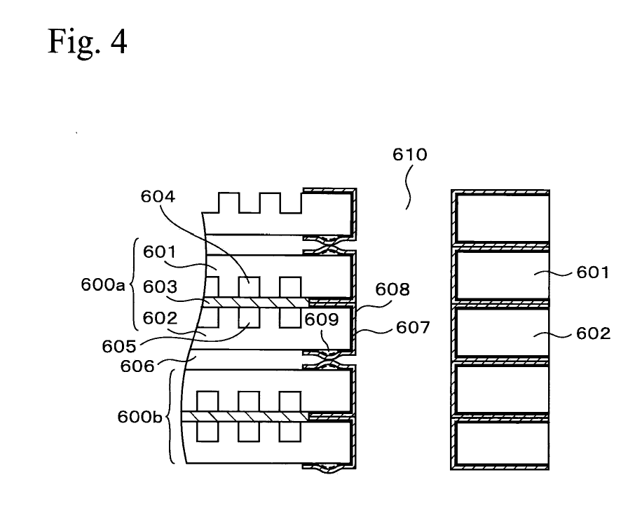

Next, an effect in which the blisters are prevented from forming by improving properties of the primer layer is explained. FIG. 2 is a graph showing the relationship between (measured resistance value/calculated theoretical resistance value) of the primer layer and formation rate of blisters. The horizontal axis of FIG. 2 represents value (%) of (measured resistance value/calculated theoretical resistance value) of the primer layer. The vertical axis of FIG. 2 represents the formation rate of blisters corresponding to the values in the horizontal axis. That is, the vertical axis represents the area rate (%) of formed blisters compared to a tested surface of a sample in which an insulating coating was formed on the primer layer corresponding to the horizontal axis, which is obtained by carrying out an endurance test. The measured resistance value is a measured value of resistance in a thickness direction of the primer layer in which an aqueous electrolyte solution is dropped and penetrated thereat. The calculated theoretical resistance value is a specific resistance value of material which constitutes the primer layer, and it is a resistance value calculated on the basis of physical values of the material described in information or data books of manufacturers and a thickness of the primer layer.

In this embodiment, a silane coupling agent was used as a material of the primer layer, and the sample was obtained by coating the material on a stainless steel plate under the conditions shown in FIG. 2. In addition, as a sample for observing the formation rate of blisters, a sample in which an insulation coating having a thickness of 1 mm made of a silicone rubber was formed on the same primer layer as that in the sample for measuring (measured resistance value/calculated theoretical resistance value) was prepared. Furthermore, the endurance test for evaluating the formation rate of blisters was carried out by flowing pure water at 90° C. for 20 hours on the surface of the insulation coating of the sample maintained at 85° C.

As is apparent from the graph in FIG. 2, in the case in which the value (%) of (measured resistance value/calculated theoretical resistance value) is 95% or more, the formation of the blisters is not a problem. This is because when the value (%) of (measured resistance value/calculated theoretical resistance value) is 95% or more, the fineness of the primer layer is high, and there is rarely penetration of the aqueous electrolyte solution, and therefore, penetration of the coolant in the endurance test to the primer layer is at a low level, and the formation of the blisters, which occurs by penetration of the coolant to the primer layer, is prevented.

FIG. 3 is a schematic drawing showing a method for measuring the measured resistance value. In this embodiment, a sample in which the above primer layer 402 was formed on the stainless steel plate 401 under the coating condition described in the graph, was used. In the measurement, 0.1% NaCl aqueous solution to which a small amount of phenolphthalein was added was dropped on the primer layer 402, and resistance values between the primer layer 402 and the stainless steel plate 401 which were in the droplet 403 were measured by an MΩ tester 404. The MΩ tester 404 is an ammeter for measuring very small currents having ultra-high input resistance to measure high resistance. Here, the resistance value was measured by detecting the very small current flow under conditions in which a DC voltage of 100 V was applied. When the phenolphthalein was added, the color of the current-carrying part changed to violet after a DC voltage was applied to primer layer 402, so that it was easy to observe. The calculation of the formation rate of blisters was carried out by photographing the tested sample and performing image analysis of the photograph. The electrolyte is not limited to the NaCl aqueous solution, and any neutral electrolytes can be employed. In addition, electrolytes containing a surfactant (for example, an anionic surfactant) can also be used. In this case, since the surface tension of the electrolyte is decreased and the electrolyte is easily penetrated into finer voids, it is preferable that the surfactant be used when the material having such finer voids is used.

According to the method shown in FIG. 3, the state of the finer voids (defects) which exist in the primer layer 402 can be quantitatively evaluated. That is, in the case in which the density of the finer voids is high, the electrolytic aqueous solution remarkably penetrates and the measured resistance value is low. In contrast, in the case in which the density of the finer voids is low, the aqueous electrolyte solution barely penetrates and the measured resistance value is high (that is, it approaches the theoretical value). According to this method, the fineness of the primer layer 402 can be evaluated.

The method for evaluating properties of the primer layer using the value of (measured resistance value/calculated theoretical resistance value) is superior, since measurement is simple, reproducibility is high, and the formation of the blisters can be reliably prevented. That is, the existence of the fine voids in the primer layer in which it is difficult to directly measure can be indirectly estimated simply and accurately, and thereby the formation of the blisters can be effectively prevented.

What is claimed is:

1. A separator for a fuel cell, which contacts a coolant, comprising:
an electroconductive plate member,
a primer layer formed on the surface of the plate member which contacts the coolant, and
an insulation coating formed on the primer layer,
wherein a value calculated by (measured resistance value/calculated theoretical resistance value) of the primer layer is 95% or more.

2. The separator for fuel cell according to claim 1, wherein the measured resistance value is a resistance value of a resistance in a thickness direction of the primer layer in which an aqueous electrolyte solution penetrates.

3. The separator for fuel cell according to claim 1, wherein the insulation coating is formed on a peripheral region of a continuous hole which passes through each unit power generating cell and supplies or discharges coolant.

4. The separator for fuel cell according to claim 3, wherein the insulation coating is also formed near an edge of a gap for distributing the coolant.
